(19) United States
(12) Patent Application Publication
(10) Pub. No.: US 2011/0106908 A1
(43) Pub. Date: May 5, 2011

(54) TRANSFER OF INFORMATION BETWEEN AT LEAST TWO SOFTWARE

(75) Inventors: Juho Risku, Oulu (FI); Jukka Kortela, Oulu (FI); Mikko Hopia, Oulu (FI)

(73) Assignee: HELMI TECHNOLOGIES OY, Oulu (FI)

(21) Appl. No.: 11/577,380

(22) PCT Filed: Oct. 20, 2005
(86) PCT No.: PCT/FI2005/000455

§ 371 Date: Dec. 4, 2007

(30) Foreign Application Priority Data
Oct. 22, 2004 (FI) 20045397

(51) Int. Cl. G06F 15/16

(52) U.S. Cl. 709/217

(57) ABSTRACT

Data is transferred between two software programs. Electronic data maintained by server software is read with browser software. A document is formed from the electronic data. The data consists of a group of objects. The document is presented on the screen of a data processing device with the browser software. In addition, the electronic data is transferred between the objects of the document read by the browser software and a server software as a background run performed by a script based software language on the browser software.

### TECHNICAL FIELD

The invention is concerned with a method for transferring information between at least two software, a device for data processing and a computer program product encoding a computer process for transferring information between at least two software.

### BACKGROUND

WWW (World Wide Web)-pages can be browsed with browser programs, e.g. Netscape®, Microsoft®, Internet Explorer™, Konquor™, Mozilla™ and Mac OS X™-operative system Safari. Pages containing passive texts and images can be browsed with the browser software, but also more complex pages and documents can be made by means of them, which might contain dynamic elements and programs. Also web applications can be run with the browser software in other words programs, in which information is transferred to the display of the data processing device to be seen by the user, for example over an internet connection. Data in a server system can be studied with web applications or it can be modified.

The applications to be used by the www browsers are often based on the HTML- or XHTML page description languages based on which the www browser software interprets the marks in the description language to a www page. Typically, when the user wants to see new information, he clicks on a link on a page on the display with the mouse. As a consequence, the browser software sends a request to the server maintaining the page, after which the server sends a new www page to the browser. Thus the browser software download information from the server one page or document at a time.

In addition to actual data and alternating information, a lot of such information is downloaded in connection with the downloading of the www page that has to do with the design and the structure of the page and which necessarily does not even change when going from one page to another. The amount of this additional information is especially significant in such www applications which have a lot of tables and a relatively rich user interface.

The fact that data is downloaded one page or document at a time causes several problems. Firstly, the sending of a request to the server for downloading a page and the receiving of a reply from the server can cause a relatively long delay before new information is available. During the downloading, the user can not perform other functions. When the whole HTML page is downloaded again, the www-browser also has to draw it up completely once again. Also this operation causes a delay. The downloading of unnecessary information and of the description language around the information causes extra traffic and delay. Furthermore, because the page is updated only when the user clicks on the link (or in some cases it takes place automatically by given intervals with the refresh command) the alternating information is not necessarily up to date. Furthermore the user does not know if some information has changed or if it should be updated. The fact that a lot of unnecessary information has to bee transferred and treated in connection with a piece of individual information also causes different scalability problems at the server end. In front of everything, the problem is however that the user does not necessarily get immediate feedback from the user interface to his function and the use of the application is divided into periods of clicking-waiting.

In prior art, the problem has been tried to solve in different ways. Usually, different plug-in software is used as well as applications or parts of applications built on those (e.g. Java, ActiveX and Flash). In these solutions, the dynamic updating of data is restricted to the scope of the plug-in software and the data transferred to the browser program by the plug-in is not used to change the data on the page or the user interface of the page. There is such a problem involved in this solution that each plug-in needs a software installation to the user device and in addition, the user has to have the right version of the software. Furthermore, a suitable plug-in software is not necessarily available for all environments or browsers. There might also be differences between the plug-in software in different device platforms, in other words, plug-in software of the same version can be different for some parts depending on device platform.

### BRIEF DESCRIPTION

The object of the invention is to perform a method and a device performing the method is such a way that an improved data transfer is achieved between at least two software. As one aspect of the invention, there is presented a method of performing a data transfer between at least two software wherein electronic data maintained by the server software is read in the method by means of a browser software; a document is formed of the electronic data, the document consisting of a group of objects and the document is presented with the browser software on the screen of the data processing device, electronic data is transferred with the browser software between the objects of the document read by the browser software and the server software as a background run performed by a script based software language.

One aspect of the invention is a data processing device comprising a browser software for downloading electronic data maintained by a server software for forming a document of electronic data in such a way that the document comprises a group of objects and for storing the document in the data processing device and for presenting the formed document on the screen of the data processing device. The data processing device comprises a data transfer module performed by a script based software language, which is configured to transfer electronic data between the objects of the document read by the browser program and the electronic data maintained by the server software as a background run.

One aspect of the invention is also a computer program product encoding the computer process to perform data transfer between at least two software, which computer process comprises: reading electronic data maintained by a server software with a browser software; forming a document of the electronic data, the document consisting of a group of objects and presenting the document with the browser software on the display of the data processing device, transferring the electronic data between the objects of the document read by the browser software and the electronic data maintained by the server software as a background run performed by a script based software language.

One aspect of the invention is also a data processing device comprising a server software to maintain electronic data consisting of objects; for receiving a downloading request from a browser software, for transferring electronic data to the browser software on the basis of the request of the browser software. The server software of the data processing device is configured to maintain electronic data in a database following the same document object model in which the browser software maintains the downloaded electronic data in such a way that each object of the model has been stored separately and to transfer electronic data to the browser software controlled by a data transfer model performed with a script based software language run in the browser software.

One aspect of the invention is also a computer program product encoding a computer process for performing a data transfer between at least two software, which computer process comprises: maintaining electronic data consisting of objects; receiving a downloading request from the browser software, transferring electronic data to the browser software on the basis of the request of the browser software, maintaining electronic data in a database which follows the same document object model in which the browser software maintains the downloaded electronic data in such a way that each object of the model has been stored separately and transferring electronic data to the browser software controlled by a data transfer model performed with a script based software language run in the browser software.

Several advantages can be reached with the invention. The solution of the invention enables real time updating of data of a document, such as a web application, without the need to download a completely new page and so that the user does not experience any delay in connection with the downloading. The solution enables downloading of data in the background of other use so that the user does not feel any interruption in the use of the application. There is no need to install any software in the browser software and there is no continuous need for updating. The solution works as such in known browsers.

In a solution of an embodiment, the document downloaded by the browser comprises a hidden element which is not shown on the display of the data processing device. The browser software downloads the script based software language of the browser by using data maintained by the server software in to the hidden element of the document from which the visible part of the document is updated.

The solution also enables the function of the web application in off-line status with out any plug-in software in such a way that also the modifications made by the user into the application are transferred to the server the next time the user is connected to the server via the network. This also make a use of the application possible in situations in which the device has no connection to the server via the network.

The solution also saves server and data transfer capacity. In addition, the scalability of the web applications increases remarkably with respect to the richness of the user interface and to the amount of users. Generally, an increase in complexity and interface properties causes problems for the scalability. In the solution presented, there are no problems with the scalability as a consequence of the more complex and richer user interface. The solution enables an interaction in real time between the user and the application in the same way as in convential client-server applications.

The solution presented can be applied not only in browser software of today and in applications on them, but also in any other solutions based on page description languages in which such software is used for presenting script language that can be controlled by program commands built inside the script language.

In the solution presented, any such script language or command language can be used that is understood by the browser software and before which the transfer from the server to the browser software is not translated to any special form that can be run. The script language can be any software language internally known by the browser software.

In one embodiment, the browser software and the server software can be different parts of the same software system.

### LIST OF DRAWINGS

The invention is now described more in detail in connection with some advantageous embodiments by referring to the enclosed drawings in which

FIGS. 1A-1C present different browser environments;

FIGS. 2A-2B illustrate examples of structures of data processing devices;

FIG. 3 illustrates an embodiment of the invention by means of a flow scheme;

FIG. 4 illustrates another embodiment of the invention by means of a flow scheme;

FIGS. 5A-5D presents some embodiments for the data transfer

FIG. 6 is a signal sequence diagram illustrating an embodiment, and

FIG. 7 illustrates an example of a server performance

### DESCRIPTION AN EMBODIMENTS

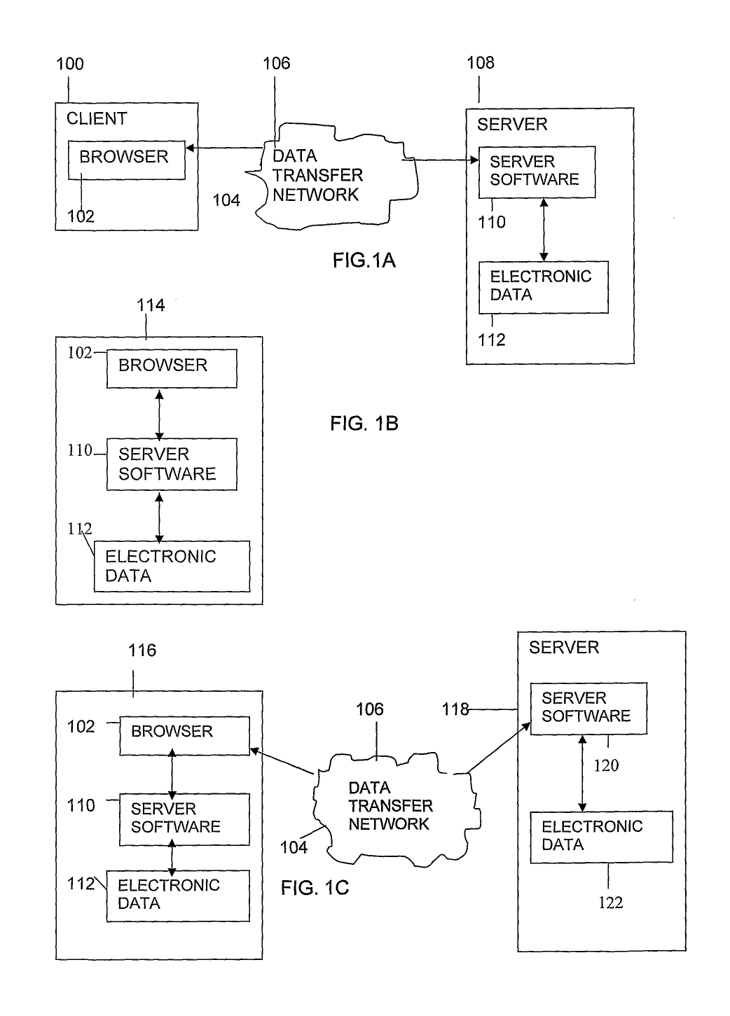

Conventionally, the term browser software means a software intended to repeat WWW (World Wide Web) pages, for example software mentioned in the background part. FIG. 1A describes a function of a browser software in a client server architecture. The browser software 102 is situated in a client device 100.

The client device 100 can for example be a computer, a laptop, a PDA (Personal Digital Assistant), a user terminal of a radio system, such as a mobile phone, or some other known data processing device of prior art. The client device 100 has a data transfer connection 104 to the server 108 via a data transfer network 106. The data transfer network 106 can for example be a wired data transfer network, such as Internet, or a private network or a wireless data transfer network, such as GSM (Global System for Mobile Communications) or UMTS (Universal Mobile Telecommunications System). Wired and many wireless data transfer networks nowadays generally use TCP/IP (Transmission Control Protocol/Internet Protocol), but also other suitable data transfer protocols can be used. The wireless data transfer networks are either not restricted only to said examples of mobile station systems, as also other suitable wireless data transfer networks can be used. One example of other wireless data transfer networks is WLAN (Wireless Local Area Network), for example the one defined in the standards of series 802.11 of IEEE (The Institute of Electrical and Electronics Engineers, Inc). Another example of wireless data transfer networks is the Bluetooth network realized for short distance radio senders/receivers. The server software 110 is at the server 108 with which electronic data 112 is processed. The browser 102 can request desired electronic data from the server software 110 to be processed.

The browser program 102 can however also be used in other kind of environments than in those client/server architectures described in FIG. 1A. An embodiment is described in FIG. 1B, wherein both the browser 102, the server software 110 and the electronic data 112 to be processed are in the same data processing device 114. Thus, in such a data processing device 114, there is not necessarily the possibility to form a data transfer connection with other devices. Then electronic data fetched from other places are not browsed with the browser software 112, as was done in FIG. 1A, instead the browser software 102 forms a user interface to local electronic data 112.

In addition to that documents can be repeated with the browser 102, the browser 102 can also otherwise form a part of the user interface of the data processing device, in other words data of other type than documents only can be presented with it. The document can also form a source code for an entire application. The document can also be generated dynamically with the server 108.

In FIG. 1C, there is described an embodiment, wherein the browser 102, the server software 110 and a part of the electronic data 112 to be processed are in the same data processing device 116. In addition, there is a data traffic connection 104 from the device to another device 118 through a data transfer network 106, in which device 118 there is a server software 120 with which electronic data 122 is processed. The browser software 102 can request desired electronic data to be processed both from the server software 110 and from the server software 118. An example of such a solution is a solution in which the construction of the desired document is loaded from local data 112 and variable information is loaded from another server through a telecommunication network.

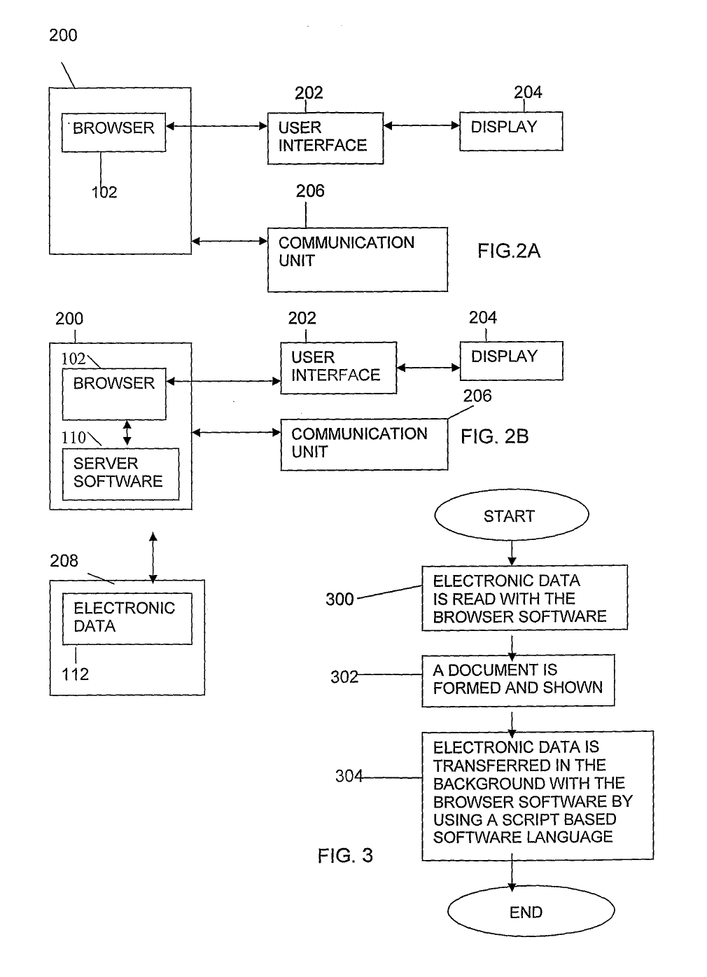

The data processing device to be used for the processing of electronic data can thus be a client device 100 of a type presented in FIG. 1A and/or an independent or partly independent data processing device 114 or 116 of a type described in FIGS. 1B and C or 116. In FIG. 2A, there is generally described the construction of a data processing device to be used for processing of electronic data. The data processing devise contains a processing unit 200 and a user interface 202. The interaction between the user and the data processing device and its programs is performed with the user interface 202. The user interface 202 can also contain a display 204. The user interface 202 can also contain for example the following elements: a keyboard, a pointing device, a loudspeaker, a microphone, or other user interface elements of prior art. The processing unit 200 can for example be a microprocessor with memories, for example a microprocessor used in PCs manufactured by Intel or AMD. Operative systems (for example Windows or Symbian) and application software can be run in the processing unit 200. One application software is a browser software 202 to be used for processing of electronic data. In addition, the data processing device can comprise a communication unit 206 with which it can form a data traffic connection 104 to another data processing device. The communication unit can be performed in known ways.

In FIG. 2B, the structure of a second data processing device to be used for processing electronic data is generally described. In this example, the device is for other parts like the device of FIG. 2A, comprising a processor unit 200, a user interface 202, a display 204, but it furthermore comprises a memory 208 in which electronic data 112 can be stored. A server software 110 can be run in the processor unit, which software 110 maintains electronic data 112. The server software can in this case be any software by means of which electronic data can be read and written. The device of FIG. 2B can also comprise a communication unit 206. The memory 208 can be performed in known ways such as with fixed memory circuits or memory cards that can be changed.

FIG. 3 illustrates an embodiment of the invention by means of a flow scheme. The browser software 102 reads electronic data 112 maintained by the server software 110 in step 300. The electronic data can contain program code, for example a program code made by some markup language or command language (script language). The following can be mentioned as examples of markup languages: HTML (Hypertext Markup Language), XHTML (Extensible HTML), DHTML (Dynamic HTML), XML (Extensible Markup Language), and examples of command languages are JavaScript developed by Netscape® and Jscript developed by Microsoft® or VBScript. The markup language or the command language can be any known language supported by some browser or a language defined by some standard. For example the standard of ECMA (Ecma International—European association for standardizing information and communication systems), ECMA-262, defines the ECMAS-script command language.

A document is formed of electronic data in step 302 and a document is presented with the browser software on the screen 204 of the data processing device. In step 304, electronic data is transferred behind other use between the document read with the browser software and the server software by using a script based software language without downloading the whole document again.

In one embodiment, a document object model is formed of the electronic data with the browser software and reference is made to the objects of the document via the document object model. The structure of the document can follow for example the DOM standard (Document Object Model). W3C (World Wide Web Consortium) has defined the DOM standard. DOM is a platform and language neutral connection through which programs and series of commands dynamically can use and update the content, structure and style of documents. DOM defines the programming interface, in other words the API (Application Programming Interface) by use of which the programmer can form documents. Additional information of DOM can be obtained from the W3C web site, the address being www.w3.org when writing this. The are different versions of DOM such as for example DOM Level 2 or DOM Level 3.

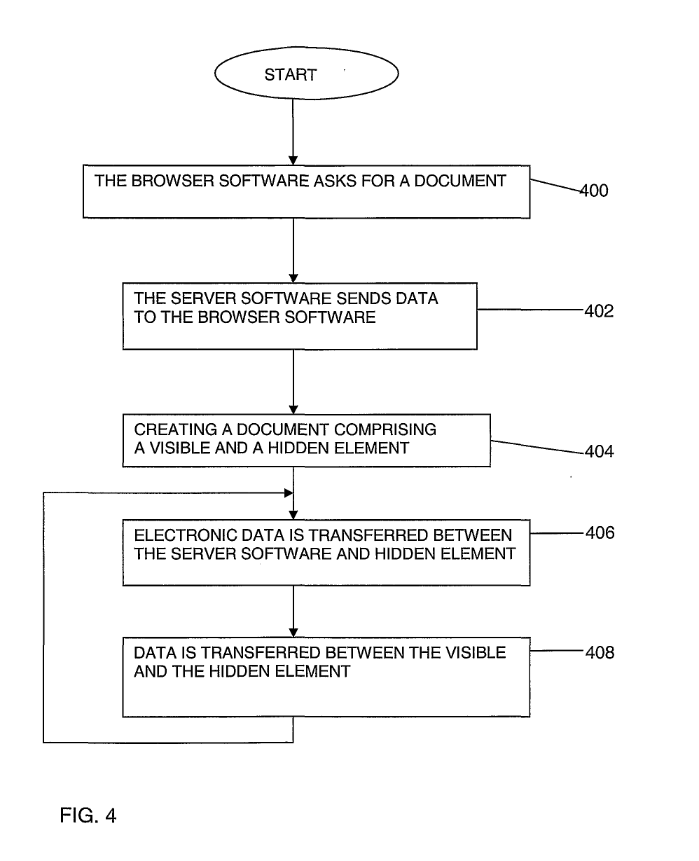

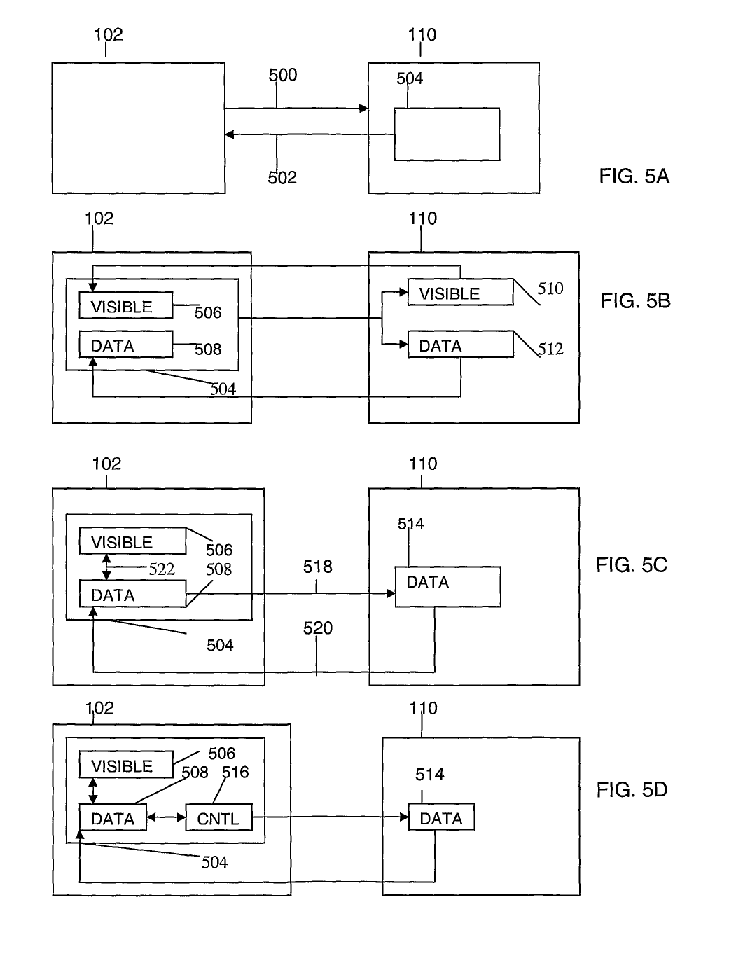

An example of the solution of the invention is studied by referring to FIGS. 4 and 5A-5D. Both the browser software 102 and the server software 110 have been presented in the figures. The server software can be run either in a different data processing device than the browser software or in the same data processing device.

In step 400, the browser software 102 requests a new document or page from the server software according to FIG. 5A. This typically takes place on the basis of the choice of the user. The user has possibly chosen some link or written a site address to the address field of the browser software.

In step 402, the server software 110 receives a message 500 and sends 502 electronic data 504 in accordance with the request to the browser software 102 in accordance with FIG. 5A. In this example, the electronic data forms the structure document 504, which contains a structure to which the real page is downloaded. The structure document 504 thus comprises for example an HTML-code that is read and performed by the browser software 102. The structure document can contain frames which are performed for example by means of <FRAME> or <IFRAME> tags. The tags are parts of the HTML-script language. Also other corresponding structure elements exist.

In this embodiment example, there is talked about HTML-code. The document to be downloaded can also be any file that can be downloaded by means of the server software 112, such as for example XML, HTML, XHTML, CSS (Cascading Style Sheets) or Java script file. The document can for example be a web application or the document can contain a web application.

In step 404, the browser software 102 receives electronic data from the server software 110 and creates a document 504, which comprises a visible element 506 and a hidden element 508 according to FIG. 5B.

The structure document 504 can comprise a code by means of which the visible element 506 and the hidden element 508 are formed. The document can for example comprise an HTML-code according to which the browser software 102 downloads electronic data 510, 512 from the server software by means of which the visible and the hidden elements are formed. These can also be separate documents. Document 510 can comprise a user interface element 506 and a corresponding document object model. The structure of the document can for example follow the DOM (Document Object Model) standard.

Document 512 can comprise data which is written in the fields of the user interface element.

In one embodiment, the structure document 504 can also comprise a script, which performs a program which forms the visible element 506. In this case a corresponding document 510 is not needed.

The visible and the hidden elements 506, 508 can for example be performed as frames by using <FRAME> or <IFRAME> tags. The elements can also be any other HTML elements to which data can be downloaded from an external source, of which at least one element is hidden from the user and at least one element is visible for the user. The visible and the hidden elements 506, 508 comprise objects according to the document object model which for example can be fields to which data is downloaded. However, it has to be noted that the document object model enables modification of any object. The modification and the presentation of data is thus not restricted to any given object types, as for example to form fields.

In step 406, electronic data 514 is transferred 518, 520 between the hidden element 508 and the server software by using a script based software language according to FIG. 5C. In step 408, data can be transferred 522 between the hidden element 508 and the visible element 506. The visible element of the document is thus updated on the basis of the data in the hidden element. During these steps, the user can use the visible element 506 without any interruptions in the use. In FIG. 4, steps 406 and 408 are presented as a loop but naturally one can leave the loop if the user for example gives a command to the browser software 102 to download a completely new page. This is not illustrated in FIG. 4 of clarity reasons.

The hidden element 508 can send electronic data to the server software 112 on the basis of the interaction performed with the visible element 506. Correspondingly, the hidden element 508 can ask the server software 110 to send electronic data on the basis of the interaction performed with the visible element 506. Thus, there is no need to download the whole document again when some part of the document needs updating. The user does not feel any interruption or additional delays caused by the downloading of the document as the transfer of data takes place in the background at the same time as interaction with the visible element is possible all the time.

In one embodiment of the invention, when a change is observed in electronic data 514 maintained by the server software, corresponding changes are transferred to the document read by the browser software. Correspondingly, when a change is observed in the objects of the visible element, the changes are transferred to the objects comprised by the electronic data maintained by the server software.

In one embodiment, the electronic data maintained by the server software is stored in the data base consisting of the objects. The electronic data maintained by the server software is for example stored in a database of the DOM standard (Document Object Model) as a relation model. When a change is observed either in the objects of the document read by the browser software or in the electronic data maintained by the server software, from which the document was read, the altered data can be updated also to the other end. The server software can for example maintain electronic data in a database which follows the same document object model as the one in which the browser software maintains the electronic data downloaded by it in a such a way that each object of the model is separately stored.

If a relation database is made from the document object model and the electronic data has been stored in the relation database, updating of data can be done only internally in the relation database. In that case, the changes made in the document object model can be collected from the relation database by using a very simple application ready to be sent to the browser software. This embodiment is advantageous in the sense that the load of the server software is very low.

In one embodiment, the structure document 504 can comprise more than one visible element and/or more than one hidden element. In the example of FIG. 5D there are two hidden elements. The hidden element 508 is an element used in the updating of data of a type according to the foregoing figures, but the hidden element 516 is used as a control element to which control data is downloaded from the server software 110 on the basis of which the hidden element 508 is updated. The browser software can be configured to request updating of the control element often, wherefor data can be used to control other functions of the element. There can also be several control elements, for example one element for each transfer direction. There can also be several elements 508 to be used for updating of data for example one for each transfer direction. In addition, if the browser software is in connection to more than on server software, in other words if data is transferred with several server software, there can be more than one hidden element.

Thus, the data transfer is performed on the basis of the script based software language, whereby there is no need to use solutions which are based on software to be separately downloaded, such as plug-in or ActiveX components. By using a script based software language, a data transfer module can for example be performed which is configured to transfer electronic data as a background run between objects of the document read by the browser software and electronic data maintained by the server software without the need to download the whole document again.

In one embodiment, the data processing module is separate both from the visible element 506 and the hidden element 508. The logic taking care of the data transfer is thus separate from the real data.

In one embodiment, it is preferable that the data transfer with the document presented in the browser and the electronic data maintained by the server software is regular. The data transfer module can be performed in such a way that it asks the server software whether if the data maintained by the server software has been changed, either with regular intervals or based on user activity. Thus, it is possibly to request updating of the objects of the documents from the server software. Then the altered data needing updating is transferred on the basis of the request. The server software 110 can also inform the browser software for example via the control element 516 that a change has been observed in the electronic data maintained by the server software from which the document was read. On the bases of this, the data transfer module can ask for updating of the modified data.

In one embodiment, control data of the updating of the electronic data is read from a continuous http-stream. The downloading of the document is thus not ended and the http-connection is not interrupted. Normally, when a www-document is downloaded, a http (hypertext transfer protocol) connection is formed between the server software and the browser software. After the downloading of the document, the protocol connection is interrupted. In this embodiment the http-connection is kept open even if data is not all the time sent along it. Data is sent to the document along with the receipt of new control data, in other words when the electronic data maintained by the server software is changed.

In one embodiment, the updating of electronic data to the browser software takes place over a push-function of the server software. This means that the server software sends electronic data to the browser software without any request from the browser software. The updating of data is directed to the hidden element of the document from which the visible element in turn is updated. In this embodiment, the changes in the electronic data maintained by the server software can be updated directly to the browser software.

The data transfer module can work in two directions: on one hand it collects the modifications made by the user in the visible element 516 of the document 504 and enters the data and sends information to the server software on the background, on the other hand it takes care of that the modified parts of the data maintained by the server software are downloaded from the server software in the background regularly. Only the modifications in the document object model are updated, whereby data transfer capacity is saved.

In one embodiment, the server software starts to collect data after the downloading of the structure document in the data maintained by it from the modifications made to the file. The data can be forwarded to the data transfer module when requested and on the basis of the data sent, the data transfer module can request for updating of data. Also priority can be given for the modifications. Then the most important changes can be updated faster.

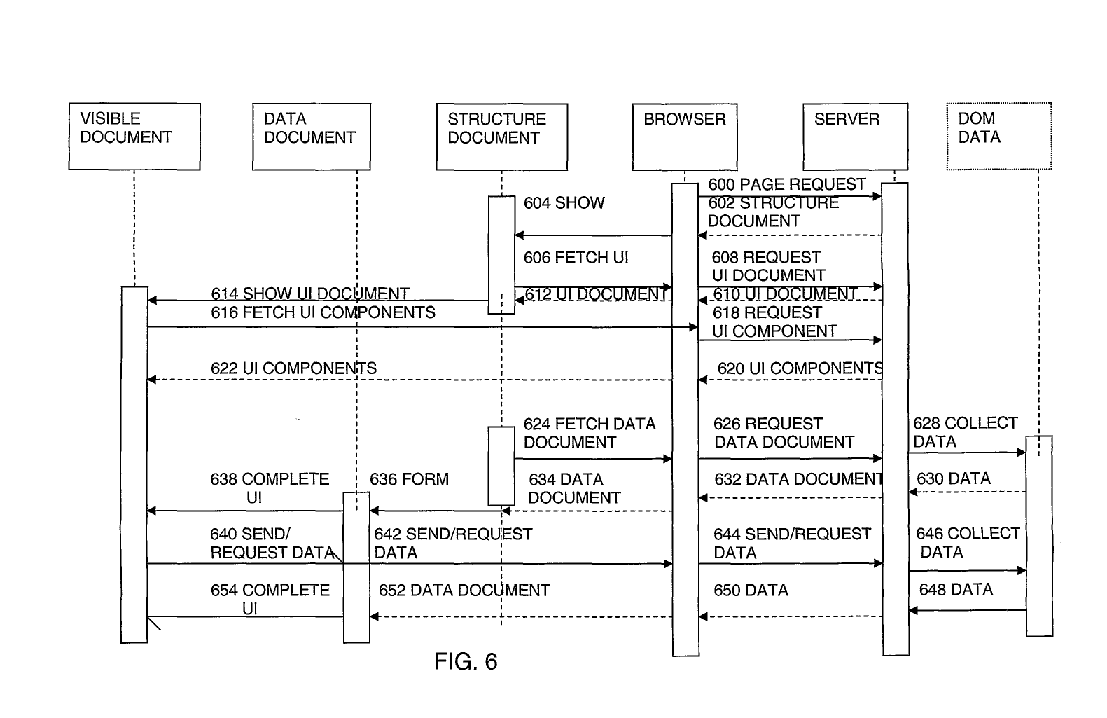

FIG. 6 presents a signal sequence diagram, which illustrates one embodiment. When the user uses the browser and marks the desired things in a document, the browser sends 600 a request to the server that it wants the document in question. The server returns 602 the document to the requester. In this example, the server returns the structure document to the requester, which document contains the structure to which the real page is downloaded. The structure document might contain visible elements which are shown 604 to the user.

The structure document can comprise a code by means of which the visible and the hidden elements are formed. The structure document requests 606 for the user interface document. The user interface document forms the visible element. The browser sends 608 the user interface document request to the server. The server sends 610 the user interface document to the browser, which forwards 612 it to the structure document, which shows 614 the visible element, in other words the document visible for the user.

For the user, the visible document requests 616 for user interface components from the browser. The browser sends 618 the user interface component request to the server. The server sends 620 the user interface components to the browser, which forwards 622 it to the visible document. The visible element can request the components needed at that moment or components to be needed later.

Next, the structure document requests 624 downloading of the hidden data document from the browser. The browser sends 626 the data document request to the server. The server collects 628 the data from the data base maintained by the server software, which database is stored for example in a form according to the DOM (Document Object Model) standard. The data concerning the document on the server can thus be stored in a document object model identical with the document in the browser or with the part of the document. The DOM database sends 630 data to the server, which sends 632 it to the browser. The browser forwards 634 the data to the structure document, which forms 636 the data document, in other words the hidden element. The user interface can be completed 638 with data in the data document.

The downloading of the visible and hidden elements can also be started simultaneously. Each frame and document element can be downloaded independently from each other.

Thus, the visible element is formed of the document of the visible element and the user interlace components, which for example can be script files, and/or contains HTML elements. The visible element takes care of that the user interface components are presented for the user in the browser. The visible element and the user interlace components get the data from the hidden element. The visible element and the components contain information on how the data is presented. Also information about how data is presented can be connected to the hidden element.

The visible element can also request user interlace components via the hidden element, whereby the downloading of components takes place in the background. Components to be needed immediately can be priorized and they can be sent first and the downloading of components to be needed later can be delayed.

When the user interface once has been downloaded and presented and when the data downloaded via the data document has been presented, the data to be presented in the user interface is updated along with the operations of the user. The data can be transferred in both directions between the server and the user interface. The data can be updated in the ways described earlier also in such a way that the server informs the necessity of the updating of the data.

The visible document can on the basis of the actions of the user be started 640 for sending/updating of data. The data document then sends 642 a request to the browser, which sends 644 a request of sending/updating data to the server. The data is either stored in a database or it is collected 646 from the database. The collected data is sent 648 to the server which sends 650 it to the browser. The browser sends 652 the data to the data document, which 654 updates the visible document.

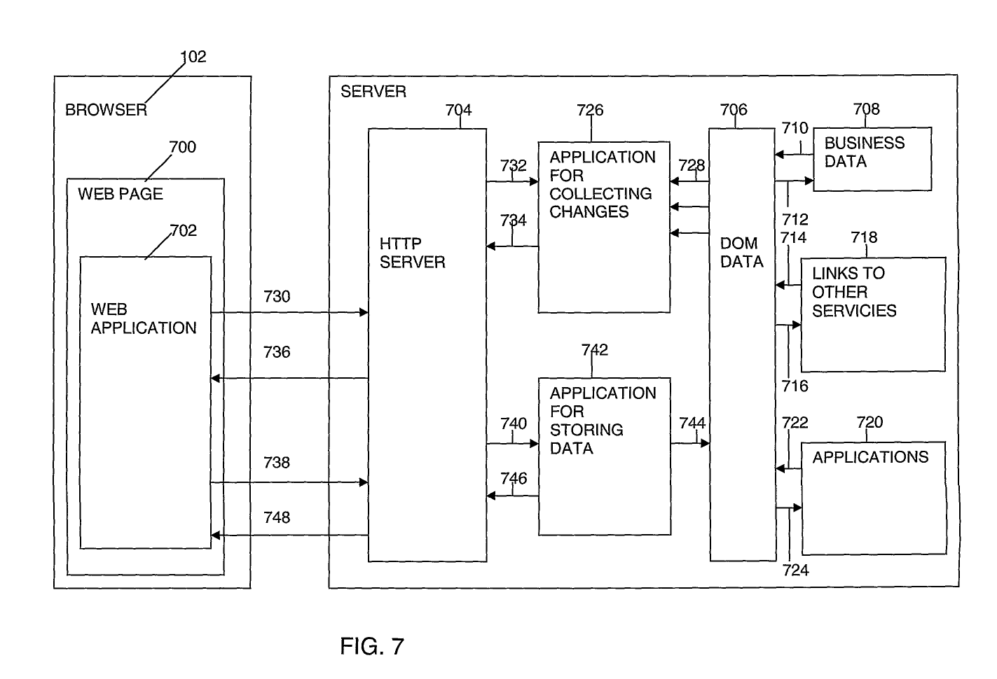

In FIG. 7, an embodiment of the invention is illustrated especially for the part of the server. In the figure, there is presented the browser 102, which is connected to the server 108. A web document or web page 700 is downloaded to the browser, which comprises a web application, which data can seen on the server or it can be modified.

In this example it is assumed that the web-application is in connection to the server by using the http-protocol. The server hereby comprises http server software 704.

The data of the document 700 is downloaded and stored on the server. The electronic data concerned with the document 700 on the server 108 is stored in a document object model identical with the document or with a part 702 of the document in the browser 102, in a DOM database 706 which for example consists of a relation database. This enables electronic data to be modified and updated very simply and in many ways. The structure balances the load of the server. The updating and transfer of data in form of DOM-objects can thus be carried out in such a way that only the modified data is updated and transferred. The part of the data that has not changed can be left without any updating or transfer. This decreases the load of the server and the traffic between the server and the browser.

DOM-data can for example be updated from database 708, which for example can be a database connected to business, which database is in relation with DOM-data. When the database 708 is updated, the changes are transferred 710 to DOM-data. Correspondingly, when DOM-data is updated, the information of the changes 712 are transferred to the database 708. There can naturally be corresponding connections from the database 708 to DOM-data also of other web-applications, in other words the same database 708 can be watched modified by using several web applications.

DOM-data can also be updated 714 from external connections, services or databases 718 from which modifications in DOM-data can be forwarded 716.

DOM-data can also be updated via applications 720. The applications can update 722 DOM-data or read 724 DOM-data. It is easy to carry out these applications thanks to the document object model.

The server 108 can comprise an application 726 which collects data from the modifications of the DOM-database. The modifications 728 of the DOM-data are thus forwarded to the application 726.

When the web application 702 sends a data 108 request or a request 730 for updating of data to the http-server software 704, the http-server software 704 sends 732 the data update request further to the application 726. The application sends 734 the modified data to the http-server software which sends 736 it to the web application.

Also the web application can update data to the DOM-database. The web application sends modified data 738 to the http-server software 104 of the server 108. The http-server software 704 sends 740 the received modified data further to the storing application 742, which updates 744 DOM-data 706. The storing application 742 sends a receipt 746 to the http-server software, which sends 748 it to the web application 702.

The solution presented in one embodiment has been performed as a computer program. The computer program can be stored in a storing media which can be read by a computer or a data processing device. The storing means can for example be a memory read by a computer, a software package, a signal that can be read by a computer or a compressed software file that can be read by a computer.

Even if the invention above is described with reference to examples presented in the enclosed drawings it is clear that the invention is not restricted to those but instead it can be modified in many ways in the scope of the enclosed patent claims.

1. A method for data transfer between at least two software, comprising:
reading electronic data maintained by a server software with a browser software;
forming a document of the electronic data, which document consists of a group of objects;
presenting the document with the browser software on a screen of the data processing device, and
transferring electronic data with the browser software between the objects of the document read by the browser software and the server software as a background run controlled by a script based software language.

2. The method of claim 1, wherein the electronic data is transferred without downloading the document again.

3. The method of claim 1, wherein a document object model is formed with the browser software of electronic data and the objects of the document is referred to via a document object model.

4. The method of claim 1, wherein the document comprises a hidden element, which is not shown on the a display of the data processing device and the browser software downloads data maintained by server software to the hidden element of the document controlled by a script based software language, from which hidden element a visible element of the document is updated.

5. The method of claim 1, wherein a document is formed of electronic data in the browser software, the document has a visible element visible to a user and an element hidden from the user, electronic data is transferred between the hidden element and the server software controlled by a script based software language of the browser software independently from the visible element and the visible element is updated with data from the hidden element controlled by a script based software language of the browser software.

6. The method of claim 1, wherein the electronic data to be read comprises a script based program code and the objects of the document to be presented on the screen of the data processing device are updated by using a program run by the script based program code.

7. The method of claim 1, wherein changes are observed in the electronic data maintained by the server software from which the document was read and corresponding changes are transferred to the document read by the browser software.

8. The method of claim 7, wherein the changes are transferred as soon as the changes are observed.

9. The method of claim 7, wherein the browser software requests updating of the objects of the document and the changes are transferred on the basis of the request.

10. The method of claim 7, wherein the changes are transferred with predetermined intervals.

11. Moved The method of claim 7, wherein the server software informs the browser software that there has been a change observed in the electronic data maintained by the server software from which the document was read.

12. The method of claim 1, wherein the electronic data maintained by the server software is stored in a database consisting of objects.

13. The method of claim 12, wherein when a change is observed in the objects comprised by the electronic data maintained by the server software, corresponding changes are transferred to the document read with the browser software.

14. The method of claim 12, wherein when a change is observed in the objects of the document read by the browser software, the changes is transferred to the objects comprised by the electronic data maintained by the server software.

15. The method of claim 1 wherein the document structure follows a DOM (Document Object Model) standard.

16. The method of claim 1 wherein the script based program language follows a JavaScript syntax.

17. The method of claim 1 wherein the script based program language follows an ECMAScript syntax.

18. The method of claim 1 wherein the electronic data maintained by the server software is stored in a form of a relation model in a database following a DOM (Document Object Model) standard.

19. The method of claim 1, wherein a change is observed either in the objects of the document read by the browser software or in the electronic data maintained by the server software from which the document was read and electronic data is always transferred when a change is observed in either one of them.

20. The method of claim 1, wherein the server software is run in a different data processing device than the browser software.

21. The method of claim 1, wherein the server software is run in the same data processing device as the browser software.

22. The method of claim 4, wherein the document consists of at least two frames of which at least one frame is hidden from a user and at least one frame is visible to the user.

23. The method of claim 22, wherein the frame that is visible to the user comprises a user interface and the frame that is hidden from the user is a data frame to which a script based software language is downloaded by using data maintained by the server software from which data the frame that is visible to the user is updated.

24. The method of claim 23, wherein the frame hidden from the user is a control frame to which control data is downloaded from the server software on a basis of which the data frame is updated.

25. The method of claim 3, wherein an element that is hidden from a user comprises a script file.

26. The method of claim 1, wherein the document is a web application.

27. The method of claim 4, wherein the document consists of at least two HTML-elements to which data are downloadable from an external source of which at least one element is hidden from a user and at least one element is visible to the user.

28. A data processing device comprising:
a browser software for downloading of electronic data maintained by a server software,
a document of electronic data formed in such a way that the document comprises a group of objects,
the document being stored in the data processing device and presented on a screen of the data processing device, and
the data processing device having a data transfer module performed with a script based software language, which is configured to transfer electronic data as a background run between the objects of the document read by the browser software and electronic data maintained by the server software.

29. The data processing device of claim 28, wherein the browser software is configured to store the document in the data processing device, the document having a hidden element which is not shown on a screen of the data processing device and a data transfer module is configured to download data maintained by the server software to the hidden element of the document and to update the visible part of the document from the hidden elements.

30. The data processing device of claim 28, wherein when observing a change in the objects of the document as read by the browser software, the browser software is configured to send the information of the changes to the server software.

31. A computer process for performing a data transfer between at least two software, comprising:
a server software maintaining electronic data;
reading the electronic data with a browser software;
forming a document of electronic data consisting of a group of objects;
presenting the document with the browser software on a screen of a data processing device,
transferring electronic data as a background run controlled by a script based software language between the objects of the document read by the browser software and electronic data maintained by the server software.

32. The computer process of claim 31 wherein the process further comprises forming a document from electronic data in the browser software, the document comprising an element that is visible to a user and an element that is hidden from the user,
transferring electronic data between the hidden element and the server software controlled by a script bases software language of the browser software independently of the visible element and updating the visible element with electronic data from the hidden element controlled by a script based software language of the browser software.

33. A data processing device, comprising:
electronic data maintained by a server software, the electronic data consisting of objects for receiving a downloading request from a browser software for transferring electronic data to the browser software on the basis of a request from the browser software,
the server software of the data processing device being configured to maintain electronic data in a database following a document object model in which the browser software maintains the electronic data downloaded, and
each object in the document object model being stored separately to transfer electronic data to the browser software controlled by a data transfer module performed by a script based software language run by the browser software.

34. The data processing device of claim 33, wherein the server software of the data processing device comprises an application that is configured to collect data from the changes in the database and to forward the information of the changes to the server software.

35. A method for encoding a computer process with a computer program product for performing a data transfer between at least two software, comprising:
maintaining electronic data consisting of objects;
receiving a downloading request from the browser software,
transferring electronic data to the browser software on the basis of the request from the browser software;
maintaining electronic data in a database following a document object model in which the browser software maintains electronic data downloaded by the browser software storing each object in the document object model separately, and
transferring electronic data to the browser software controlled by a data transfer module by means of a script based software language run with the browser software.

36. The method of claim 35 wherein the method further comprises collecting data of changes in the database and forwarding the information of the changes to the browser software.

37. The method of claim 35 wherein the method further comprises updating the database from other databases and/or applications.
